(19) United States
(12) Patent Application Publication
(10) Pub. No.: US 2012/0108107 A1
(43) Pub. Date: May 3, 2012

(54) SCREW TERMINAL SYSTEM AND METHOD

(75) Inventors: Peng P. Chen, Shanghai (CN); An A. Wang, Shanghai (CN)

(73) Assignee: Rockwell Automation Technologies, Inc., Mayfield Heights, OH (US)

(21) Appl. No.: 13/282,348

(22) Filed: Oct. 26, 2011

(30) Foreign Application Priority Data
Nov. 1, 2010 (CN) 201020618113.5

(51) Int. Cl. H01R 13/40; B29C 31/00

(52) U.S. Cl. 439/625; 264/272.14

(57) ABSTRACT

A terminal assembly is provided for accommodating stripped wires and ring lugs. The assembly includes a fastener and clamp plate, the fastener being secured to a base by threaded engagement. A wire to be terminated may be inserted through an access window and secured between the clamp plate and base, with the threaded fastener serving to urge the clamp plate downwardly on the wire. For terminating ring lugs, the fastener may be raised to upper position where it is retained by elastic deformation of retaining elements within the assembly housing. Once the ring lug is inserted the fastener and clamp plate may be released and the termination completed.

### BACKGROUND

The present invention relates generally to the field of electrical terminal connections, and more particularly to a finger-safe connection that accommodates wire conductors and ring lug connections.

A wide range of devices utilize screwed terminals for completing electrical connections. These devices range from input/output terminals, electrical relays, electrical contactors, automation controllers, circuit breakers, to mention just a few. In a typical application, a wire may be partially stripped of insulation and an exposed conductive end inserted into the terminal connection. A fastener may be tightened down onto the wire to complete the electrical connection. In many industrial and other applications, the fastener is provided with a plate that is pressed down on the wire by application of force by the head of a screw fastener.

Other arrangements exist for accommodating ring lugs. In these arrangements a ring-like conductive element is secured to the end of a wire, such as by crimping. The ring is typically inserted between a threaded plate and a fastener, and the fastener is tightened down onto the ring lug to make the desired connection. These arrangements typically require that the fastener be extracted from the threaded base to allow the ring to be placed and the fastener to be lowered into an aperture of the ring.

In certain applications it is desirable that access to these connections be limited. That is, openings may be reduced in size such that fingers of operators, maintenance personnel, and others cannot be easily inserted into spaces where the termination has been made. Little or no development has been made, however, for combination termination assemblies that can adequately accommodate both wire and ring lug conductors. Those arrangements that had been proposed are often costly, require various spring biasing arrangements, and are relatively complex in design.

There is a need, therefore, for improved arrangements that can permit wires and ring lugs to be terminated effectively and in a relatively cost-effective manner.

### BRIEF DESCRIPTION

The present invention provides a novel termination assembly designed to respond to such needs. The assembly may be configured as a “finger-safe” arrangement wherein access apertures are reduced in size while still permitting effective termination of both wires and ring lugs. The proposed designs allow for wires to be effectively terminated between a base and a clamp, which is forced into place by a threaded fastener. The threaded fastener may be easily raised to create a space between the fastener and the base for insertion of a ring lug. The fastener may be held in a raised position by retaining features that are molded into a housing. These retaining features hold the fastener and the clamp, temporarily, for insertion of the ring lug. The fastener and clamp may be easily dislodged from the retaining surfaces to terminate the ring lug connection.

In accordance with one aspect of the invention, therefore, a terminal assembly comprises a housing, a threaded base disposed in the housing, a threaded fastener engaged in the base, and a clamp plate disposed about the fastener and in facing relation to the base. An elastically deformable structure is disposed in the housing and configured to engage a head of the fastener in a raised position in which the elastically deformable structure retains the fastener and the clamp plate in a spaced relation to the base.

In accordance with another aspect of the invention, a terminal assembly comprises a housing, a threaded base disposed in the housing, a threaded fastener engaged in the base, and a clamp plate disposed about the fastener and in facing relation to the base. Elastically deformable prongs are molded into the housing and configured to engage a head of the fastener in a raised position in which the elastically deformable prongs retain the fastener and the clamp plate in a spaced relation to the base.

The invention also provides a method for making a terminal assembly. The method comprises molding a housing having elastically deformable prongs configured to engage a head of a fastener in a raised position in which the elastically deformable prongs retain the fastener and a clamp plate in a spaced relation to a base into which the fastener may be threaded for termination of a wire conductor or a ring lug.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an exemplary terminal assembly for terminating both wires and ring lugs in accordance with aspects of the invention;

FIG. 2 is a similar perspective view illustrating internal components of the assembly with a fastener and clamp being exploded from the assembly housing for illustrative purpose;

FIG. 3 is a detailed view of a portion of one of the terminals shown in the previous figures illustrating an exemplary configuration for the fastener, clamp and retaining features in the housing, along with a threaded base disposed in the housing; and

FIG. 4 is a view of the assembly of FIG. 3 showing the fastener and clamp raised to a retained position for insertion of a ring lug into the terminal assembly.

### DETAILED DESCRIPTION

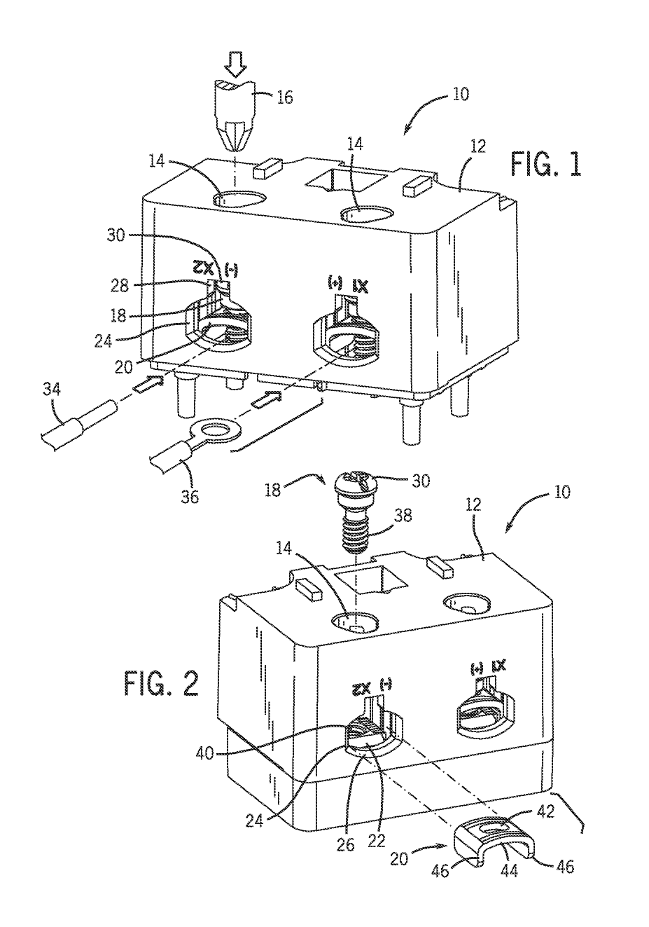

FIG. 1 illustrates an exemplary terminal assembly in accordance with certain aspects of the invention. The terminal assembly 10 may be incorporated into a wide range of devices, such as input/output assemblies, relays, contactors, automation controllers, circuit breakers, just to mention a few. The assembly comprises a terminal housing 12 which may itself be formed as several separate parts and assembled into the structure illustrated. The housing 12 has one or more tool apertures 14 that extend through the housing and permit access to the inner components as described below. A tool, such as a screwdriver 16 may be inserted through the tool apertures for effectuating the desired terminations, and for loosening the terminations for extraction of conductors. Within the housing a fastener 18 is secured, in this case in the form of a threaded screw. The screw cooperates with a clamp plate 20 as described more fully below to allow for termination of wires and ring lugs. The clamp plate is placed in facing relation to a base 22 into which the fastener is threaded.

The fastener 18 and the clamp plate 20 are accessible through an access window 24 formed in the housing 12. In the presently contemplated embodiment illustrated, the access window 24 has a lower enlarged portion 26 and an upper extension 28. The enlarged portion 26 is dimensioned to allow for insertion of as well as for insertion of wires, ring lugs, and so forth. The upper extension 28 allows for access to the head of the fastener for urging the fastener into an upper retained position as described below. Thus, the fastener head 30 can be seen through the upper extension 28 of the access window. It should be noted that, in a presently contemplated embodiment, the fastener 18 and clamp plate 20 form a subassembly that cannot be separated once joined. The subassembly of these components is inserted into the elements that will form the housing 12 prior to final assembly of the housing. Other arrangements and assembly techniques may, however, be envisaged that nevertheless conform to the claimed invention.

The clamp plate 20 along with the fastener 18 and base 22 establish a cavity in which a wire 34 may be inserted. As with conventional structures, it is intended that the wire be partially stripped to expose conductors within the wire. These are contacted by the clamp plate 20 and fastener 18 as well as by the base 22 to terminate the electrical connection in a manner similar to conventional devices. Moreover, the structure is designed to accommodate ring lugs as indicated by reference numeral 36. As with conventional ring lug structures, the ring lugs that may be used with the illustrated arrangement include a generally closed ring of conductive material secured to a wire conductor that is to be terminated. As described more fully below, the structure allows for removal of the fastener, biasing the fastener and clamp plate in a raised position to expose a space through which the ring lug may be inserted. Thereafter, the fastener and clamp plate may be lowered such that the fastener extends through the aperture in the ring lug.

FIG. 2 is an exploded perspective view of the arrangement of FIG. 1. As shown in FIG. 2, the fastener 18 has a threaded section 38 below the head 30. The fastener 18 and clamp plate 20 are shown exploded from the cavity in the housing in which they are normally lodged. The clamp plate itself fits over threads 40 formed in the base 22. The base will typically be formed of a conductive metal and may have serrations or other retaining features formed in an upper surface thereof that can cooperate with the conductive material of the wire and spring lug to enhance the electrical connection and more easily retain the wire when used. The clamp plate in the illustrated embodiment has an aperture 42 through which the fastener extends. In the illustrated embodiment a clamp plate has an arcuate top 44 that aids in enveloping the terminated wire and spring lugs. Downwardly extending sides 46 are contiguous with the arcuate top and further aid in retaining and terminating wires and spring lugs.

In a presently contemplated embodiment, for assembly, a subassembly is formed of the fastener 18 and clamp plate 20, and the subassembly is placed in components that form the housing. Electrical connections with the base (not illustrated) are then disposed within the housing. The fastener 18 and clamp plate 20 are thus contained within the housing.

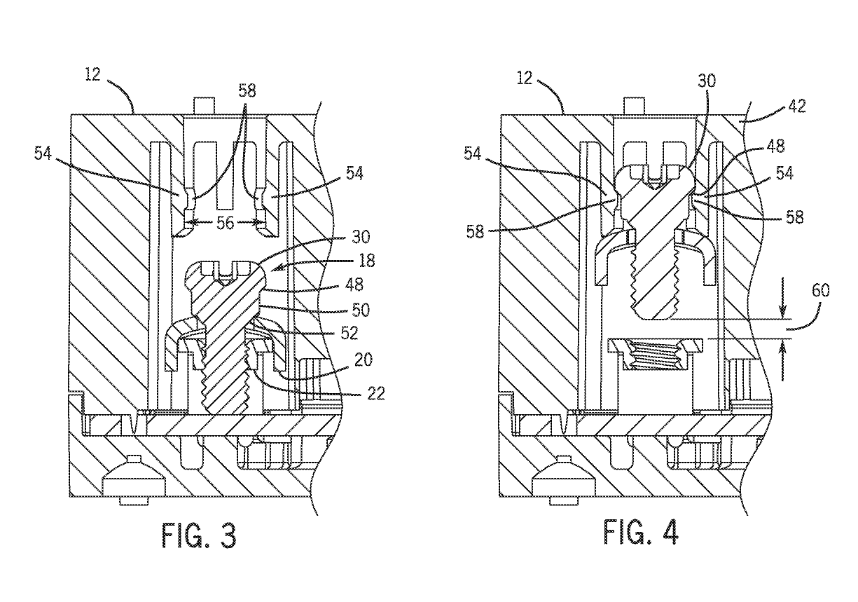

FIG. 3 illustrates these components following assembly. As shown in FIG. 3, the fastener 18 is screwed into the base 22 through the clamp plate 20. The particular form of fastener may assist in the function of both clamping and termination as well as retention of the fastener and clamp plate in a raised position as described below. In particular, in the illustrated embodiment the fastener head 30 has a lower taper 48. Below the taper a shoulder 50 is formed with a shoulder taper 52. The shoulder taper may assist in forcing the clamp plate 20 into tight engagement on wires and ring lugs. Moreover, it should be noted that in the illustrated embodiment the aperture formed in the clamp plate (see FIG. 2) is slightly smaller than the threads formed on the fastener. These threads are initially forced through the clamp plate during assembly. Thus, when the fastener is unscrewed from the base 22, it will carry the clamp plate upwardly by a contact with the upper threads.

To retain the fastener and clamp plate in a raised position, the housing 12 has internal features that contact and retain the fastener (with the clamp plate, in turn, retained by the fastener threads). In particular, in a presently contemplated embodiment prongs 54 extend downwardly within a molded body of the terminal housing. Two, three, four or more such prongs may be provided. The prongs form resilient structures that may be elastically displaced (i.e., bent slightly) to allow the head 30 of the fastener to enter into a region between the prongs, and thereafter spring inwardly hold the head in a raised position. An entry end 56 is defined between the prongs that can receive the head of the fastener. The internal surfaces of the prongs allow the fastener to bend the prongs in an elastic manner outwardly as the fastener and clamp plate are raised. Protrusions 58 are formed in the prongs that interact with the lower taper 48 of the fastener head to hold the fastener in a raised position.

FIG. 4 illustrates the same arrangement with the fastener in a raised position. For this operation, the fastener is first fully disengaged from the threads of the base by a tool that is inserted through the tool aperture 14 (see, FIG. 1). A tool, such as a straight-blade screwdriver may be inserted through the access aperture to contact the head of the fastener. The fastener may then be urged upwardly by movement of this tool into the upper extension 28 of the access window (see, FIGS. 1 and 2). Such force may also be applied to a lower side of the clamp plate. As shown in FIG. 4, once the fastener is sufficiently raised, the protrusions 58 of the prongs 54 contact the fastener head to hold it in this raised position. No other structures, springs or assemblies are required for this purpose. In a raised position, a clearance space 60 is defined between a lower extremity of the fastener and the base 22. This base is sufficiently large to allow a ring lug to be inserted between the fastener and the base. Once the ring lug is inserted, a tool may be pressed through the tool aperture, contacting the head of the fastener, to overcome the retaining force of the protrusions, thereby releasing the fastener and clamp plate. The fastener may then be re-threaded into the base to capture the ring lug and complete the termination.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A terminal assembly comprising:
a housing;
a threaded base disposed in the housing;
a threaded fastener engaged in the base;
a clamp plate disposed about the fastener and in facing relation to the base; and
an elastically deformable structure in the housing configured to engage a head of the fastener in a raised position in which the elastically deformable structure retains the fastener and the clamp plate in a spaced relation to the base.

2. The terminal assembly of claim 1, wherein the clamp plate has an aperture for receiving the fastener and is retained on the fastener in the raised position by contact with threads of the fastener below the aperture.

3. The terminal assembly of claim 1, wherein the clamp plate has an arcuate upper section.

4. The terminal assembly of claim 1, wherein the elastically deformable structure is molded into the housing.

5. The terminal assembly of claim 1, wherein the elastically deformable structure comprises a plurality of prongs extending towards the fastener and spaced from one another sufficiently to allow the head of the fastener to enter between the prongs.

6. The terminal assembly of claim 5, wherein the prongs are molded into the housing.

7. The terminal assembly of claim 5, wherein the prongs comprise protrusions that engage the head of the fastener in the raised position.

8. The terminal assembly of claim 7, wherein the head of the fastener comprises a lower surface configured to receive the prongs to retain the fastener in the raised position.

9. The terminal assembly of claim 1, wherein the housing comprises an access opening through which a conductor may be inserted for termination between the clamp plate and the base.

10. The terminal assembly of claim 9, wherein the access opening comprises a lower enlarged section through which the clamp plate is inserted, and an upper extension configured to receive a tool that contacts the fastener or the clamp plate to urge the fastener and the clamp plate towards the raised position.

11. A terminal assembly comprising:
a housing;
a threaded base disposed in the housing;
a subassembly of a threaded fastener engaged in the base and a clamp plate disposed about the fastener and in facing relation to the base; and
elastically deformable prongs molded into the housing and configured to engage a head of the fastener in a raised position in which the elastically deformable prongs retain the fastener and the clamp plate in a spaced relation to the base.

12. The terminal assembly of claim 11, wherein the prongs comprise protrusions that engage the head of the fastener in the raised position.

13. The terminal assembly of claim 11, wherein the head of the fastener comprises a lower surface configured to receive the prongs to retain the fastener in the raised position.

14. The terminal assembly of claim 11, wherein the housing comprises an access opening through which a conductor may be inserted for termination between the clamp plate and the base.

15. The terminal assembly of claim 14, wherein the access opening comprises a lower enlarged section through which the clamp plate is inserted, and an upper extension configured to receive a tool that contacts the fastener or the clamp plate to urge the fastener and the clamp plate towards the raised position.

16. A method for making a terminal assembly, comprising:
molding a housing having elastically deformable prongs configured to engage a head of a fastener in a raised position in which the elastically deformable prongs retain the fastener and a clamp plate in a spaced relation to a base into which the fastener may be threaded for termination of a wire conductor or a ring lug.

17. The method of claim 16, comprising assembling a subassembly of the fastener and the clamp plate, and disposing the subassembly in the housing.

18. The method of claim 17, wherein the prongs comprise protrusions that engage the head of the fastener in the raised position.

19. The method of claim 18, wherein the head of the fastener comprises a lower surface configured to receive the prongs to retain the fastener in the raised position.

20. The terminal assembly of claim 17, wherein the access opening comprising a lower enlarged section through which the clamp plate is accessible, and an upper extension configured to receive a tool that contacts the fastener or the clamp plate to urge the fastener and the clamp plate towards the raised position.
